(19) United States
(12) Patent Application Publication
(10) Pub. No.: US 2009/0039648 A1
(43) Pub. Date: Feb. 12, 2009

(54) WATER SUPPLY HOSE CONNECTOR FOR WASHING MACHINE

(76) Inventor: Su-Young LEE, Changwon (KR)

Correspondence Address: KED & ASSOCIATES, LLP, P.O. Box 221200, Chantilly, VA, 20153-1200, US

(21) Appl. No.: 12/187,825

(22) Filed: Aug. 7, 2008

(30) Foreign Application Priority Data
Aug. 10, 2007 (KR) 10-2007-0080909

(51) Int. Cl. F16L 41/00

(52) U.S. Cl. 285/136.1

(57) ABSTRACT

A water supply hose connector for a washing machine comprises: a body portion having a screw thread on an inner surface thereof so as to be directly coupled to a tap having a screw thread; a hose connection portion formed below the body portion, and connected to a water supply hose that supplies water to a washing machine; a flange portion formed between the body portion and the hose connection portion, and outwardly protruding than the body portion; and a sealing member mounted in the body portion. Accordingly, bolts, etc. need not be used to connect the water supply hose connector to the tap, and efforts to concentrically form the water supply hose connector with the tap are not required. Accordingly, not only a user, but also an engineer can conveniently install the water supply hose connector for a washing machine.

### RELATED APPLICATION

The present invention relates to subject matter contained in priority Korean Application No. 10-2007-0080909, filed on Aug. 10, 2007, which is herein expressly incorporated by reference in its entirety.

### BACKGROUND OF THE INVENTION

1. Field of the Invention

The present invention relates to a water supply hose connector for a washing machine, and more particularly, to a water supply hose connector for a washing machine capable of reducing installation time and occurrence of water leakage by being configured so as to be directly connected to a tap having a screw thread at the end thereof.

2. Description of the Background Art

Generally, a water supply hose for supplying water to be used in washing and rinsing processes is coupled to a tap by a coupling device such as a connector.

FIGS. 1A to 1D are views showing processes for connecting a tap and a water supply hose with each other in accordance with the conventional art, and FIG. 2 is an exploded perspective view of a water supply hose connector of FIG. 1D.

As shown in FIGS. 1A to 1D, an intermediate connection member 2 is connected to a tap 1 having a screw thread 1a at the end thereof. A water supply hose connector 3 is connected to the end of the intermediate connection member 2. And, a water supply hose 5 is connected to the water supply hose connector 3. Under this configuration, water can be supplied to a washing machine.

Here, the water supply hose connector 3 may be directly connected to the end of the tap 1 not via the intermediate connection member 2.

For convenience and stability in mounting the water supply hose 5 to the water supply hose connector 3, may be further provided a hose connection member 6 connected to the end of the water supply hose 5.

As shown in FIG. 2, the water supply hose connector 3 is connected to the tap 1 or the intermediate connection member 2 by tightening coupling members such as bolts at a plurality of coupling holes 4a formed at the water supply hose connector 3 in a circumferential direction with a certain gap therebetween. Here, it difficult to concentrically form the water supply hose connector 3 with the tap 1 or the intermediate connection member 2, which may cause water leakage.

More concretely, if the same force is not applied in tightening the bolts of the water supply hose connector 3, or if a moving distance of the bolts is not constant, the water supply hose connector 3 is not concentric with the tap 1 or the intermediate connection member 2. This may cause water leakage.

Especially, since the intermediate connection member 2 has the end of a small outer diameter, it is more difficult to concentrically connect the intermediate connection member 2 with the water supply hose connector 3. This difficulty was caused not only by a user, but also by an engineer.

Furthermore, in order to connect the water supply hose connector 3 to the tap 1, the intermediate connection member 2 has to be additionally installed, and a coupling means such as bolts has to be used to couple the water supply hose connector 3 to the tap 1. This may cause a user's inconvenience at the time of an assembly process.

According to an investigation result for installation circumstances of a washing machine by the present applicant, a tap having a screw thread, that is, a coupling-mounted tap occupies about 64% of all kinds of taps. However, a bolt coupling type connector is being currently used, thereby not utilizing the screw thread type tap.

Furthermore, even if the water supply hose connector is concentrically formed with the tap or the intermediate connection member, water leakage may occur due to an imperfect sealing state therebetween.

### SUMMARY OF THE INVENTION

Therefore, it is an object of the present invention to provide a water supply hose connector capable of being directly connected to a tap having a screw thread without using an intermediate connection member, or without using coupling bolts.

It is another object of the present invention to provide a water supply hose connector capable of being conveniently installed not only by a user but also by an engineer without causing inconvenience in being concentrically formed with a tap.

It is still another object of the present invention to provide a water supply hose connector having a sealing member for preventing water leakage between a tap and the water supply hose connector, and having a double-sealing structure.

It is yet still another object of the present invention to provide a water supply hose connector having a high mechanical intensity and high abrasion resistance by being injection molded with using polyoxymethylene material, and capable of being prevented from being easily damaged at the time of a coupling process.

To achieve these and other advantages and in accordance with the purpose of the present invention, as embodied and broadly described herein, there is provided a water supply hose connector for a washing machine, comprising: a body portion having a screw thread on an inner surface thereof so as to be directly coupled to a tap having a screw thread; a hose connection portion formed below the body portion, and connected to a water supply hose that supplies water to a washing machine; and a sealing member mounted in the body portion.

Under the configuration, efforts to concentrically form the water supply hose connector with the tap are not required, and bolts need not be additionally used to couple the water supply hose connector to the tap. Accordingly, installation time is reduced, and convenience is enhanced at the time of an assembly process.

One or more hook locking portions are formed at a side surface of the body portion, and a hook of a hose connection member mounted to the hose connection portion is locked by the hook locking portions. Accordingly, the hose connection member and the body portion are coupled to each other.

Here, the hook locking portion is concavely formed at a side surface of the body portion, and a concaved depth of the hook locking portion becomes deeper towards the center of the body portion. Since the hook locking portion is concavely formed at a side surface of the body portion, the hose connection member can be stably coupled to the hook locking portion. Also, an amount of injection moldings used to form the water supply hose connector is reduced.

An injection molding groove may be formed at the body portion, which reduces an amount of injection moldings, and reduces a weight of the water supply hose connector.

The water supply hose connector is formed of polyoxymethylene resin having a high mechanical strength and high abrasion resistance. Accordingly, the water supply hose connector can be used for a long time, and even if the water supply hose connector is coupled to the tap with an excessive force, the water supply hose connector is prevented from being torn away or damaged.

A sealing member mounting portion for mounting the sealing member may be formed below the screw thread of the body portion. The sealing member mounting portion is formed by a mechanical process after injection molding the body portion, etc. Since the body portion is formed of polyoxymethylene having excellent mechanical process characteristics, the sealing member mounting portion can be easily processed.

The sealing member mounting portion is concavely formed on an inner surface of the body portion, and has a diameter equal to or larger than a diameter of a valley portion of the screw thread. Accordingly, even if the sealing member is pressed while coupling the water supply hose connector to the tap, the sealing member can be firmly mounted to the sealing member mounting portion without being detached therefrom.

Here, the sealing member mounting portion may be configured so that a lower portion thereof can form a stepped portion of a certain height from a mounting surface for the sealing member. Due to the stepped portion, even if the sealing member is pressed by the tap, the sealing member is deformed to cover the stepped portion. Accordingly, water leakage can be effectively prevented.

A pressurization protrusion may be formed on a mounting surface for the sealing member on the inner surface of the body portion. Preferably, the pressurization protrusion has a height lower than that of the stepped portion.

While coupling the water supply hose connector to the tap, the sealing member is deformed by the tap that presses the sealing member. At the same time, the sealing member is strongly adhered to the stepped portion and the pressurization protrusion. Here, an adhesion force between the sealing member and the pressurization protrusion having a relatively lower height is less than an adhesion force between the sealing member and the stepped portion. Under this configuration, at the time of water leakage occurrence, the pressurization protrusion firstly prevents water leakage, and the stepped portion secondly prevents water leakage. Accordingly, water leakage can be effectively prevented.

A protrusion or a groove for mounting the water supply hose is formed on an outer surface of the hose connection portion, thereby facilitating connection between the water supply hose or the hose connection portion with the water supply hose connector.

The sealing member is formed of Chlorobutyl rubber, an+d has an inner diameter smaller than an inner diameter of the hose connection portion.

According to another aspect of the present invention, there is provided a water supply hose connector for a washing machine, comprising: a body portion directly coupled to a tap having a screw thread, and having a double-sealing structure; and a sealing member mounted in the body portion, for reducing a leakage amount of water supplied from the tap.

Here, the double-sealing structure includes a sealing member mounting portion formed on an inner surface of the body portion, for mounting the sealing member; and a pressurization protrusion formed at a part where a lower surface of the sealing member is mounted.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A to 1D are views showing processes for connecting a tap and a water supply hose with each other in accordance with the conventional art;

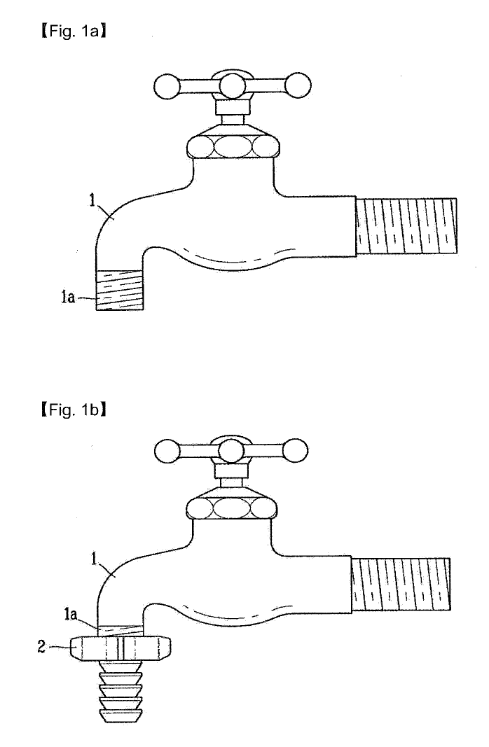

FIG. 2 is an exploded perspective view of a water supply hose connector of FIG. 1D;

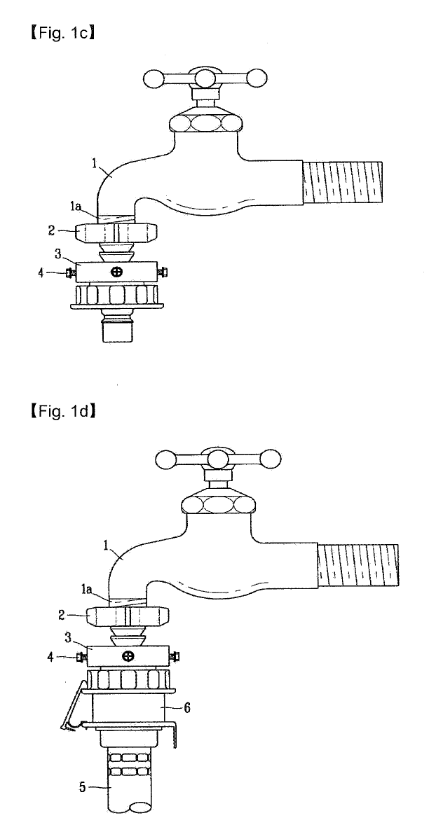

FIGS. 3A to 3C are views showing processes for connecting a tap and a water supply hose with each other according to a first embodiment of the present invention;

FIG. 4 is a perspective view of a water supply hose connector of FIG. 3B;

FIG. 5 is a sectional view taken along line ‘V-V’ in FIG. 4;

FIG. 6 is an enlarged sectional view of a part of ‘A’ in FIG. 5; and

FIG. 7 is a perspective view of a sealing member of FIG. 4.

### DETAILED DESCRIPTION OF THE INVENTION

Reference will now be made in detail to the preferred embodiments of the present invention, examples of which are illustrated in the accompanying drawings.

Hereinafter, configurations and operations of a water supply hose connector for a washing machine according to the present invention will be explained in more detail. The following description represents many aspects that can be claimed, and constitutes a part of detailed description about the present invention.

Detailed explanation about well-known functions or configurations will be omitted so as to implement the present invention more distinctly.

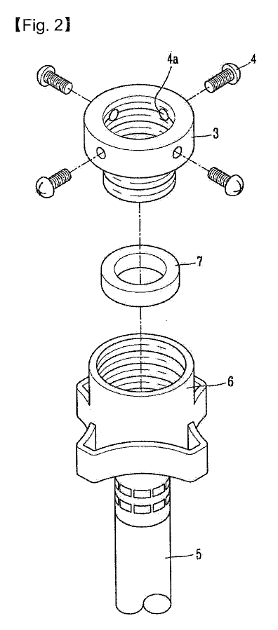

A process for connecting a water supply hose to a tap according to a first embodiment of the present invention will be explained in more detail with reference to FIGS. 3A to 3C.

Firstly, a water supply hose connector 100 for a washing machine is directly connected to a screw thread 1a of a tap 1, and a water supply hose 150 is connected to the water supply hose connector 100. Here, a hose connection member 151 may be connected to the water supply hose 150. In this case, a hook 152 of the hose connection member 151 couples the water supply hose connector 100 and the water supply hose 150 with each other by being locked by the water supply hose connector 100.

Here, the hose connection member 151 is operated in one touch manner.

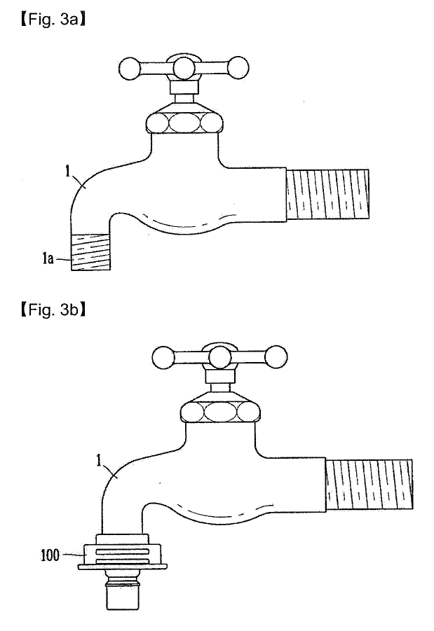

Detailed configurations of the water supply hose connector 100 for a washing machine will be explained in more detail with reference to FIGS. 4 to 7.

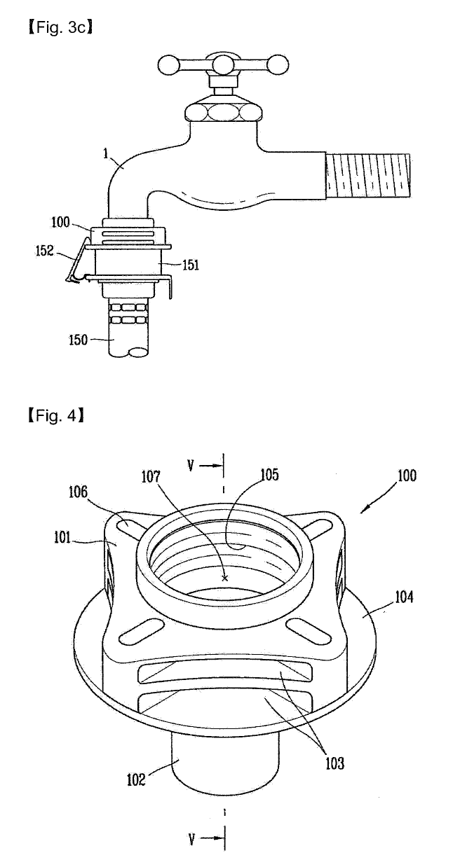

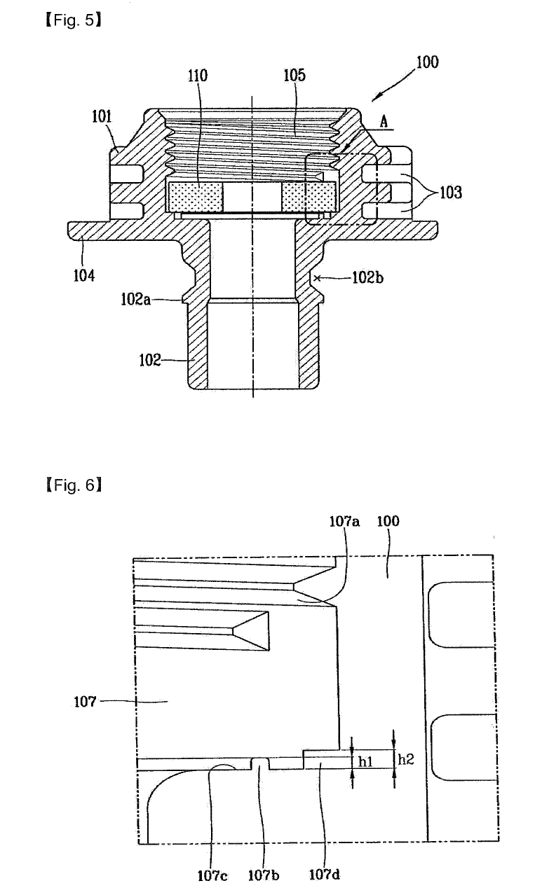

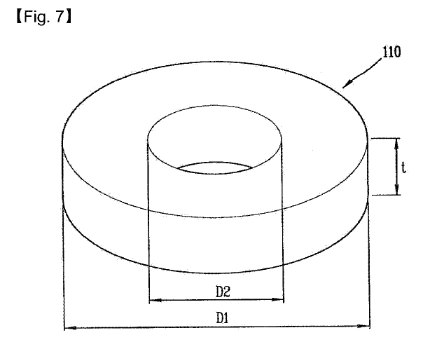

FIG. 4 is a perspective view of a water supply hose connector of FIG. 3B, FIG. 5 is a sectional view taken along line ‘V-V’ in FIG. 4, FIG. 6 is an enlarged sectional view of a part of ‘A’ in FIG. 5, and FIG. 7 is a perspective view of a sealing member of FIG. 4.

As shown in FIG. 4, the water supply hose connector 100 for a washing machine according to a first embodiment of the present invention comprises: a body portion 101 having a screw thread 105 on an inner surface thereof so as to be directly coupled to a tap 1 having a screw thread 1a; a hose connection portion 102 formed below the body portion 101, and connected to a water supply hose 150 that supplies water to a washing machine; a flange portion 104 formed between the body portion 101 and the hose connection portion 102, and outwardly protruding more than the body portion 101; and a sealing member 110 mounted in the body portion 101.

A cavity for inserting the tap 1 having the screw thread la is formed at a central part of the body portion 101.A screw thread 105 engaged with the screw thread 1a of the tap 1 is formed at an upper part of the cavity.

A sealing member mounting portion 107 for mounting the sealing member 110 is formed at a lower side of the screw thread 105.

A body portion having a nearly hexahedron shape is provided integrally with the cavity. One or more hook locking portions 103 are formed at a side surface of the body portion 101. A hook 152 of the hose connection member 151 is coupled to the hook locking portion 103.

Here, the hook locking portion 103 is concavely formed at a side surface of the body portion 101, and a concaved depth of the hook locking portion 103 becomes deeper towards the center of the body portion 101. As the hook locking portion 103 is concavely formed, the body portion 101 formed in an injection molding manner reduces an amount of injection moldings.

Two or more hook locking portions 103 are formed at each side surface of the body portion 101. The reason is in order to lock the hook 152 even if the hook 152 of the hose connection member 151 has a short or longer length.

The flange portion 104 is formed between the body portion 101 and the hose connection member 102, and is outwardly protruding more than a side surface of the body portion 101. The hook 152 of the hose connection member 151 may be locked to the flange portion 104. This is performed when the hook 152 of the water supply connection member 151 has a very short length.

An injection-molding groove or a zig groove 106 may be formed at the body portion 101. The molding groove 106 serves not only to support an injection molding, but also to reduce a weight of the body portion 101.

FIG. 5 shows a sectional surface of the water supply hose connector 100. A sealing member mounting portion 107 is formed below the screw thread 105 of the body portion 101, and the sealing member 110 is mounted to the sealing member mounting portion 107. Here, the sealing member 110 is formed in a cylindrical shape having a height less than an outer diameter.

At least one of a protrusion 102a and a groove 102b may be formed on an outer surface of the hose connection portion 102. The protrusion 102a or the groove 102b serves to stably couple the hose connection member 151 thereto. A plurality of ball bearings (not shown) formed on an inner surface of an upper end of the hose connection member 151 may be mounted to the groove 102b.

The water supply hose connector 100 including the body portion 101, the hose connection portion 102, and the flange portion 104 is injection molded with using polyoxymethylene.

The polyoxymethylene is a resin called as ‘POM’, and has high crystallinity and excellent mechanical strength. The polyoxymethylene is used to fabricate mechanical components such as bearing and gears due to its high oil resistance, high endurance against repetitive loads, and high abrasion resistance.

Furthermore, the polyoxymethylene is applied to various fields as a representative material of an engineering plastic due to an excellent plastic processability as well as high mechanical strength and thermal characteristics as a crystalline thermoplastic resin. The polyoxymethylene is ether-based plastic in a wide meaning, and includes polyformaldehyde (polyacetal). The polyoxymethylene denotes a chemical name.

The polyoxymethylene has a consecutive usage temperature of 95° C.˜-45° C., and has short-term thermal characteristics such as a welding point and a thermal deformation temperature. The polyoxymethylene represents an excellent durability against a long term usage in high temperature air and high temperature water. The polyoxymethylene does not show mechanical fatigue against repetitive impacts or consecutive vibration, and shows fatigue resistance to maintain a stable performance. Furthermore, the polyoxymethylene has the most excellent friction and abrasion resistance among thermoplastic resins, and can be used without oil feeding due to its self lubricating characteristic. Also, the polyoxymethylene has high elasticity, and excellent dimensional stability in high temperature and high humidity.

As shown in FIG. 6, the sealing member mounting portion 107 is concavely formed on an inner surface of the body portion 101. The sealing member mounting portion 107 is formed in a mechanical processing manner after injection molding the body portion 101, etc. Since the body portion 101, etc. is formed of polyoxymethylene having an excellent mechanical processability, the sealing member mounting portion 107 can be easily processed.

The sealing member mounting portion 107 is concavely formed on an inner surface of the body portion 101, and has a diameter equal to or larger than a diameter of a valley portion of the screw thread 105 formed at the cavity of the inner surface of the body portion 101. Accordingly, once the sealing member 110 is mounted to the sealing member mounting portion 107, the sealing member 110 is not easily detached therefrom.

While coupling the water supply hose connector 100 to the tap 1, even if the sealing member 110 is pressed by the tap 1, the sealing member 110 is prevented from being detached from the sealing member mounting portion 107. Rather, the sealing member 110 has an enhanced mounting characteristic to the sealing member mounting portion 107.

Here, the sealing member mounting portion 107 may be formed so that a lower portion thereof can form a stepped portion 107d of a certain height from a mounting surface 107c for the sealing member 110. Due to the stepped portion 107d, even if the sealing member 110 is pressed by the tap 1, the sealing member 110 is deformed to cover the stepped portion 107d. Accordingly, water leakage can be effectively prevented.

While coupling the water supply hose connector 100 to the tap 1, if the sealing member 110 pressed by the tap 1 has no deformation room, a hermetic state between the water supply hose connector 100 and the tap 1 may not be completely maintained. To prevent this, the sealing member 110 has a deformation room by a height of the stepped portion 107d, thereby maximizing a hermetic state between the water supply hose connector 100 and the tap 1.

A pressurization protrusion 107b may be formed at a mounting surface for the sealing member 110 on an inner surface of the body portion 101. Preferably, the pressurization protrusion 107b is formed to have a height (h1) lower than a height (h1) of the stepped portion 107d.

While coupling the water supply hose connector 100 to the tap 1, the sealing member 110 is deformed by the tap 1 that presses the sealing member 110. At the same time, the sealing member 110 is strongly adhered to the stepped portion 107d and the pressurization protrusion 107c. Here, an adhesion force between the sealing member 110 and the pressurization protrusion 107c having a relatively lower height is less than an adhesion force between the sealing member 110 and the stepped portion 107d having a relatively higher height. The reason is as follows. When the sealing member 110 receives the same force from the tap 1, a deformation amount occurring as the sealing member 110 is pressed by the stepped portion 107d is larger than that occurring by the pressurization protrusion 107c.

Under this configuration, at the time of water leakage occurrence between the tap 1 and the water supply hose connector 100, the pressurization protrusion 107c firstly prevents water leakage, and then the stepped portion 107d secondly prevents water leakage. Accordingly, water leakage effect can be maximized. That is, the pressurization protrusion 107c and the stepped portion 107d of the sealing member mounting portion 107 serve as a double-sealing structure, thereby greatly reducing water leakage occurrence.

The sealing member 110 is formed of Chlorobutyl rubber. Here, the sealing member 110 is formed in a cylindrical shape having a height (or thickness) less than an outer diameter. Preferably, the sealing member 110 has an outer diameter (D1) of 20 mm, an inner diameter (D2) of 7.5 m, and a thickness (t) of 4 mm.

The inner diameter (D2) of the sealing member 110 is formed to be smaller than an inner diameter of the hose connection portion 102 of the water supply hose connector 100.

The sealing member may be provided with a protrusion on a lower surface thereof, thereby effectively preventing water leakage. In this case, the protrusion of the sealing member is formed in a ring shape.

Due to the water supply hose connector 100, the tap and the water supply hose can be simply connected to each other, and fabrication cots for the water supply hose connector 100 can be reduced. Furthermore, a double-sealing structure is formed at the water supply hose connector 100, water leakage from the water supply hose connector 100 is prevented.

The water supply hose connector according to the present invention may be applied not only to a washing machine, but also to other products having a water supply hose.

The foregoing embodiments and advantages are merely exemplary and are not to be construed as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A water supply hose connector for a washing machine, comprising:
a body portion having a screw thread on an inner surface thereof so as to be directly coupled to a tap having a screw thread;
a hose connection portion formed below the body portion, and connected to a water supply hose that supplies water to a washing machine; and
a sealing member mounted in the body portion.

2. The water supply hose connector for a washing machine of claim 1, wherein one or more hook locking portions are formed at a side surface of the body portion, and a hook of a hose connection member mounted to the hose connection portion is locked by the hook locking portions, thereby coupling the hose connection member and the body portion to each other.

3. The water supply hose connector for a washing machine of claim 2, wherein the hook locking portion is concavely formed at a side surface of the body portion, and a concaved depth of the hook locking portion becomes deeper towards the center of the body portion.

4. The water supply hose connector for a washing machine of claim 2, wherein an injection molding groove is formed at the body portion.

5. The water supply hose connector for a washing machine of claim 1, wherein the water supply hose connector is formed of polyoxymethylene.

6. The water supply hose connector for a washing machine of claim 5, wherein a sealing member mounting portion for mounting the sealing member is formed below the screw thread of the body portion.

7. The water supply hose connector for a washing machine of claim 6, wherein the sealing member mounting portion is concavely formed on an inner surface of the body portion, and has a diameter equal to or larger than a diameter of a valley portion of the screw thread

8. The water supply hose connector for a washing machine of claim 7, wherein a lower portion of the sealing member mounting portion has a stepped portion formed with a predetermined height from a mounting surface for the sealing member.

9. The water supply hose connector for a washing machine of claim 6, wherein a pressurization protrusion is formed on an inner surface of the body portion where the sealing member is mounted.

10. The water supply hose connector for a washing machine of claim 8, wherein a pressurization protrusion is formed on an inner surface of the body portion where the sealing member is mounted, and the pressurization protrusion has a height lower than that of the stepped portion.

11. The water supply hose connector for a washing machine of claim 1, wherein a protrusion or a groove for mounting the hose connection member is formed on an outer surface of the hose connection portion.

12. The water supply hose connector for a washing machine of claim 1, wherein the sealing member is formed of chlorobutyl rubber.

13. A water supply hose connector for a washing machine, comprising:
a body portion having a screw thread on an inner surface thereof so as to be directly coupled to a tap having a screw thread;
a hose connection portion formed below the body portion, and connected to a water supply hose that supplies water to a washing machine; and
a sealing member mounted in the body portion,
wherein a ring-shaped protrusion is formed at a lower surface of the sealing member.

14. The water supply hose connector for a washing machine of claim 13, wherein a sealing member mounting portion for mounting the sealing member is formed below the screw thread of the body portion.

15. The water supply hose connector for a washing machine of claim 14, wherein a lower portion of the sealing member mounting portion has a stepped portion formed with a predetermined height from a mounting surface for the sealing member.

16. The water supply hose connector for a washing machine of claim 15, wherein a pressurization protrusion is formed on an inner surface of the body portion where the sealing member is mounted.
